(19) United States
(12) Patent Application Publication
(10) Pub. No.: US 2020/0288540 A1
(43) Pub. Date: Sep. 10, 2020

(54) GATEWAY AND DATA COMMUNICATION SYSTEM

(71) Applicant: Alibaba Group Holding Limited, Grand Cayman (KY)

(72) Inventors: Peisi CHU, Beijing (CN); Binghe SUN, Beijing (CN)

(21) Appl. No.: 16/802,894

(22) Filed: Feb. 27, 2020

(30) Foreign Application Priority Data
Mar. 7, 2019 (CN) 201910172908.3

(51) Int. Cl. H04W 88/16; H04L 12/28; H04L 12/24; H04W 16/14; H04W 84/18; H04W 80/04

(52) U.S. Cl. CPC H04W 88/16; H04L 12/2818; H04L 41/0806; H04W 80/04; H04L 41/0886; H04W 16/14; H04W 84/18; H04L 41/0843

(57) ABSTRACT

A gateway and a data communication system are provided in embodiments of the disclosure. The gateway in the embodiments of the disclosure comprises a processing component, and a plurality of server communication components connected to the processing component, wherein the plurality of server communication components each support different network protocols. The plurality of server communication components are each configured to establish a network connection with a server based on a respective corresponding network protocol. The processing component is configured to select at least two server communication components from the plurality of server communication components; and perform IoT data communication with the server through the at least two server communication components. The embodiments of the disclosure can improve the communication quality of the IoT data communication.

### CROSS-REFERENCE TO RELATED APPLICATIONS

This application claims the benefit of priority of Chinese Application No. 201910172908.3 filed on Mar. 7, 2019 which is hereby incorporated by reference in its entirety.

### BACKGROUND

### Technical Field

The disclosed embodiments relate to the field of network technologies, and in particular, to a gateway and data communication system.

### Description of the Related Art

In the field of Internet-of-Things (IoT), communication between devices is very frequent. For example, data generated by a device A needs to be sent to other devices such as a device B and a device C through a network, to complete data communication between the plurality of devices.

Actual deployments of IoT devices often occur in large and medium-sized event venues and other places. Given the size of these sites, long-distance communication is required. Furthermore, to simplify network setup and network configuration between the devices, an IoT gateway is used to achieve long-distance communication between devices. Currently, IoT gateways mainly rely on existing mobile communication networks. However, too many users and devices gathering in a dense area can overwhelm a mobile communication network, thereby reducing network communication quality and failing to meet service requirements.

### SUMMARY

A gateway and a data communication system are provided in embodiments of the disclosure. In the disclosed embodiments, the gateway greatly improves the communication quality of IoT dataw communication.

In one embodiment, a gateway is provided in the embodiments of the disclosure, wherein the gateway comprises a processing component, and a plurality of server communication components connected to the processing component, wherein the plurality of server communication components each support different network protocols. The server communication components are each configured to establish a network connection with a server based on a respective corresponding network protocol. The processing component is configured to select at least two server communication components from the plurality of server communication components and perform IoT data communication with the server through the at least two server communication components.

In another embodiment, a data communication system is provided in the embodiments of the disclosure, comprising the plurality of gateways described above deployed in the same venue area, wherein a plurality of network channels are established between any two gateways based on different network protocols and a first gateway is configured to send IoT data to a second gateway through at least two network channels.

Compared with existing systems in which a gateway can only implement IoT data communication with a server through a network channel, the gateway provided by the embodiments of the disclosure can perform IoT data communication cooperatively through at least two network channels formed by network connections established by at least two server communication components with the server. Therefore, the gateway can effectively improve the reliability and data synchronization rate of the IoT communication in a complex environment such as a venue area with a dense crowd, and effectively reduce the communication delay, thereby greatly improving the communication quality of the IoT data communication in the venue area.

These and other aspects of the disclosure are described in more detail in the following description of the embodiments.

### BRIEF DESCRIPTION OF THE DRAWINGS

To describe the technical solutions in the embodiments of the disclosure, accompanying drawings to be used for description of the disclosed embodiments will be briefly introduced below. Obviously, the accompanying drawings in the following description are merely some of the embodiments of the disclosure. Those of ordinary skill in the art can further obtain other accompanying drawings according to these accompanying drawings without creative efforts.

FIG. 1 is a block diagram illustrating a gateway according to some embodiments of the disclosure.

FIG. 2 is a diagram illustrating adjustment of a data packet proportion of at least two network channels according to some embodiments the disclosure.

FIG. 3 is block diagram of an embodiment of a gateway according to some embodiments of the disclosure.

FIG. 4 is a diagram of a plurality of network channels established by a first gateway and a second gateway based on different network protocols according to some embodiments of the disclosure.

FIG. 5 is diagram of a plurality of network channel established by a first gateway and a second gateway according to different network protocols according to some embodiments of the disclosure.

FIG. 6 is a block diagram of another embodiment of a gateway according to some embodiments of the disclosure.

FIG. 7 is a block diagram of an embodiment of a data communication system according to some embodiments of the disclosure.

FIG. 8 is a block diagram of another embodiment of a data communication system according to some embodiments of the disclosure.

FIG. 9 is a diagram illustrating results of testing and analyzing Wi-Fi signals in a certain venue area according to some embodiments of the disclosure.

FIG. 10 is a diagram illustrating a signal coverage test of a LoRa network deployed in a certain building site according to some embodiments of the disclosure.

FIG. 11 is a diagram illustrating a signal coverage test of a LoRa network deployed in a sports venue according to some embodiments of the disclosure.

FIG. 12 is a diagram a data communication system according to some embodiments of the disclosure.

### DETAILED DESCRIPTION

To enable those skilled in the art to better understand the solutions of the disclosure, the technical solutions in the embodiments of the disclosure are described below with reference to the accompanying drawings in the embodiments of the disclosure.

Some processes described in the description and claims of the disclosure and the accompanying drawings include a plurality of operations occurring in a specific sequence. However, these operations may not be performed in the sequence herein or performed in parallel. Sequence numbers of the operations such as (101) or (102) are used only to distinguish between different operations, and the sequence numbers per se do not imply any execution sequence. Additionally, these processes may include more or fewer operations, and these operations may be performed in sequence or in parallel. It should be noted that the descriptions such as “first” and “second” herein are used to distinguish between different messages, devices, modules, and the like; they do not imply the precedence order or limit that the “first” and “second” are of different types.

Current IoT gateways rely on existing mobile communication networks. However, in some sites or places with a large density of people, gathering of large crowds overburdens the mobile communication network and causes network paralysis and greatly lowered quality of communication between devices (e.g., an increased communication delay or a low data synchronization rate). As a result, actual service requirements cannot be met for services having certain requirements for the synchronization rate and delay of data communication between devices.

Therefore, to improve the communication quality between devices, a gateway and a data synchronization system are provided in embodiments of the disclosure, and the gateway may include a processing component and a plurality of server communication components connected thereto, where the plurality of server communication components each support different network protocols. The server communication components are each configured to establish a network connection with a server based on a respective corresponding network protocol. The processing component is configured to select at least two server communication components, and perform IoT data communication with the server through the at least two server communication components. Compared with existing systems in which a gateway can only implement IoT data communication with a server through a network channel, the gateway provided by the embodiments of the disclosure can perform IoT data communication cooperatively through at least two network channels formed by network connections established by at least two server communication components with the server. Therefore, the gateway can effectively improve the reliability and data synchronization rate of the IoT communication in a complex environment such as a venue area with a dense crowd, and effectively reduce the communication delay, thereby greatly improving the communication quality of the IoT data communication in the venue area.

The disclosed embodiments are described below with reference to the accompanying drawings in the embodiments of the disclosure. It is apparent that the described embodiments are merely some, rather than all embodiments of the disclosure. All other embodiments obtained by those skilled in the art on the basis of the embodiments in the disclosure without creative efforts fall within the scope of the disclosure.

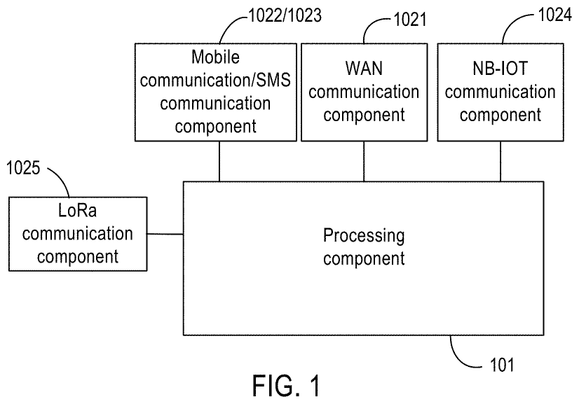

FIG. 1 is a block diagram of an embodiment of a gateway according to some embodiments of the disclosure. The gateway may include a processing component (101) and a plurality of server communication components (1021, (1022), (1023), (1024), (1025); collectively 102) connected to the processing component (101).

The plurality of server communication components (102) each support different network protocols.

The plurality of server communication components (102) are each configured to establish a network connection with a server based on a respective corresponding network protocol.

The processing component (101) is configured to select at least two server communication components (102), and perform IoT data communication with the server through the at least two server communication components (102).

The gateway is configured to implement network interconnection over a network layer, and is an intermediate device that connects two networks with different high-level protocols. In the IoT application scenario, the gateway may also be used as an IoT gateway and can also implement both wide area network (WAN) interconnection and local area network (LAN) interconnection.

For large and medium-sized sites such as a large concert venue, an exhibition venue, a tourist attraction, an airport, a station, a ranch, a farm, and a factory, terminal devices are scattered at different locations because of the large size of the actual site. Due to the limited connection capacity of each gateway, the limitation of the power of wireless signals, and the limitation of the quantity of access terminals, it is impossible for all IoT terminals to access the same gateway. Therefore, long-distance communication between the devices need to be achieved through network connections established by a plurality of gateways with a server respectively.

In one embodiment, the processing component (101) may be a high-performance Micro Control Unit (MCU) chip and may be integrated with a Central Processing Unit (CPU), a memory (ROM and/or RAM), a counter, a USB interface, a serial port, a Universal asynchronous receiver-transmitter (UART) interface, and peripheral interfaces such as Inter-Integrated Circuit (I2C), Serial Peripheral Interface (SPI), and direct memory access (DMA). Other components are connected to the processing component (101) through the peripheral interfaces.

In some embodiments, the processing component performing IoT data communication with the server through the at least two server communication components (102) may comprise establishing at least two network connections with the server through the at least two server communication components (102), and performing IoT data communication with the server based on the at least two network connections.

In some embodiments, the gateway can access, through a plurality of server communication components, a non-self-organizing network built by a network operator, such as an Ethernet/mobile communication network, a short message service (SMS) network, and a Narrow Band IoT (NB-IoT) network; and can also access a self-organizing network, such as an ultra-long-range low-power data transmission network (LoRa) network and an ad hoc (point-to-point) network, which is not limited herein.

In one embodiment, the plurality of server communication components may include more than one communication components selected from the group consisting of a WAN (WAN) communication component (1021), a mobile communication component (1022), an SMS communication component (1023), an NB-IoT communication component (1024), and a LoRa communication component (1025).

A WAN port integrated in the WAN communication component (1021) can be connected to a network cable, so that the gateway has can connect to an external WAN, thereby establishing a network connection with the server based on a WAN protocol. The WAN port requires the network cable to establish a network connection with the server. Thus, in a site where installed network cables are too complicated and extend a great distance, it is impossible to use networking wires to connect each gateway to the external WAN.

The mobile communication component (1022) may be a network card of one or a plurality of combinations of 6G/5G/4G/3G/2G systems, etc., and is connected to the server through a mobile communication base station. The network has the advantage of having a high bandwidth and short delay but also has the disadvantage of being a mobile communication network that is easily affected by dense crowds, this disadvantage causing network paralysis and thereby failing to maintain optimal communication.

For the SMS communication component (1023), the SMS communication component may also be a network card of one or a plurality of combinations of 6G/5G/4G/3G/2G systems, etc., and is connected to the server through a short message center. The short message network is characterized by an upper limit for sending a single datagram. Therefore, a data packet needs to be split and sent numerous times. At the same time, the short message network has a relatively long delay, but it is not easily affected by the external environment because of relatively effective anti-interference capability.

The NB-IoT communication component (1024) requires an NB-IoT base station to implement a connection with the server. The NB-IoT network is characterized by low power consumption and large connection. Despite its small network bandwidth, the NB-IoT network is deployed separately from the current mobile communication network, thus being capable of effectively resisting interference caused by paralysis of the mobile communication network.

The LoRa communication component (1025) requires a LoRa base station to implement a connection with the server. The LoRa network is characterized by low power consumption and long transmission distance. Even when the gateway device is at a far distance, the LoRa network still has an effective communication capability. Because the LoRa network is a self-organizing network, the network establishment is simpler and more flexible. The network can be established according to the terrain and actual requirements. However, it suffers from the disadvantage of being easily interfered by weather conditions, electromagnetic signals, and the like.

The gateway accesses a plurality of networks through a plurality of server communication components (102) and establishes network connections with the server respectively based on different network protocols, thereby forming a plurality of network channels between any two gateways. In some embodiments, the server may be a cloud server, and at the same time, cloud management and control on the IoT can be achieved.

In one embodiment, the gateway further includes a storage component configured to store a service program of the gateway and data thereof. In one embodiment, the storage component further includes a shared protocol stack queue for caching IoT data. Each communication component in the gateway can share the shared protocol stack queue of the storage component, wherein the shared protocol stack queue may include a shared send queue, a shared receive queue, and a shared retransmission queue. In some embodiments, the storage component is connected to the processing component (101) for caching the IoT data into the shared protocol queue.

It can be seen from the foregoing that different networks have different network characteristics. Therefore, different networks will be affected by different degrees of interference from the external environment, such as dense crowds, weather, interference signals in the environment, and communication data volume. Further, data transmission performance of each network channel also varies at different times. The processing component (101) configured to select at least two server communication components (102) to perform IoT data communication with the server may comprise configured to: monitor data transmission performance of a plurality of network channels formed by network connections each established between each server communication component (102) and the server; and select, according to the data transmission performance of the plurality of network channels and the volume of cached data in the send queue, at least two server communication components (102) from the plurality of server communication components (102) to perform IoT data communication with the server.

In some embodiments, the network transmission performance can represent the actual data transmission capability of a network channel. One of the most important indicators of the network transmission performance is the packet loss rate of the network. The processing component (101) can determine the data transmission quality of each network channel by monitoring the packet loss rate of the network channel in real time. At the same time, the data transmission performance of the network channel is determined with reference to the performance indicators such as bandwidth and delay of the network channel.

Therefore, with reference to the volume of cached data in the shared send queue and the data transmission performance of various network channels, at least two server communication components (102) corresponding to at least two network channels having higher data transmission performance are selected in combination to perform data transmission.

For example, when the volume of cached data is small and the various network channels all have good data transmission performance, network channels with a large bandwidth and a short delay may be preferentially selected. For example, the WAN communication component (1021) and the mobile communication component (1022) are selected to transmit IoT data.

If the Ethernet/mobile communication network is paralyzed due to a large number of users and devices, the data transmission performance of the network channel is greatly reduced, and at the same time the volume of IoT data generated surges, resulting in a large volume of data cached in the shared send queue. A plurality of server communication components (102) can be selected to send the IoT data simultaneously. For example, the NB-IoT communication component (1024), the LoRa communication component (1025), and the SMS communication component (1023) are selected to send the IoT data simultaneously for sharing the transmission pressure of each network channel, thereby ensuring that the IoT data is sent with the shortest delay and the highest data possibility.

If a certain degree of congestion occurs in the Ethernet/mobile communication network, the WAN communication component (1021), the mobile communication component (1022), and the LoRa communication component (1025) may be selected in combination to send the IoT data.

In one embodiment, the network channel may also be selected according to the service requirement. For example, in a data synchronization application scenario, if the delay and the synchronization rate of synchronous data are required to be high, the WAN communication component (1021) or the mobile communication component (1022) with a large bandwidth and a short delay is preferentially selected to transmit the IoT data. When congestion occurs in the Ethernet/mobile communication network channel, a network channel with a short delay and a large bandwidth, such as the NB-IoT communication component (1024) and the LoRa communication component (1025), is selected to assist in transmitting the IoT data, thus ensuring that data synchronization is completed quickly and accurately.

However, if the actual service has low requirements on delay and synchronization rate of the IoT data synchronization, then the data transmission of the IoT data may be performed by a self-organizing network. For example, the LoRa communication component is preferentially selected, thereby greatly reducing the operation cost of a user.

Specifically, at least two server communication components can be selected based on close considerations according to actual service requirements of the user, data transmission performance of the network channel, data volume of the communication data, and various other factors. Thus, it is ensured that data transmission capacity of the at least two network channels must be greater than the data volume of the IoT data cached in the shared send queue.

In one embodiment, the problem where the IoT data communication between the devices is affected due to network channel paralysis or congestion when only one network channel is used for IoT data communication are avoided, thereby having optimal effects on actual service processing. That is, higher communication efficiency and communication quality can be achieved by selecting at least two server communication components to cooperatively complete the IoT data communication. At the same time, the combinations of different network channels can adapt to the communication requirements in various service scenarios, and can well resist the influence of the external environment on device communication, thereby achieving stable and reliable IoT data communication.

In some embodiments, the processing component (101) caching the IoT data into the shared send queue may comprise encoding the IoT data according to a preset encoding protocol to obtain at least one data packet, and caching the at least one data packet into the shared send queue.

In some embodiments, the preset encoding protocol and a preset decoding protocol may be pre-stored in the storage component, and the preset encoding/decoding protocol may be set according to actual service data, which is not specifically limited herein. Before performing data sending, the IoT data is encapsulated and encoded according to the preset encoding protocol to obtain at least one data packet that is cached into the shared send queue.

The processing component (101) sending the IoT data to the server through the at least two server communication components (102) may comprise determining data packet proportions of the at least two server communication components (102), and sending the data packets in the shared send queue to the server through the at least two server communication components (102) according to the respective data packet proportions.

After the at least two server communication components (102) are obtained by selection, it is also necessary to set a data packet proportion of each network channel according to actual requirements. The actual data packet proportion of each server communication component is a respective data packet proportion corresponding to the network channel of the server communication component. For example, when the packet loss rate of the network channel is high, all the data packets in the shared send queue may be sent through the at least two server communication components (102), respectively. That is, the data packet proportion of each network channel is 100%. However, if the at least two network channels have low packet loss rates, but have high requirements on the actual service delay, the data packets in the shared send queue may be divided proportionally according to the transmission performance of each network channel. The data packet proportion is increased for the network channel having a short delay and a large bandwidth, and the proportion is reduced for the network channel with a small bandwidth and a high delay. For example, it is possible that the data packet proportion of the NB-IoT communication component is 40%; the data packet proportion of the LoRa communication component is 40%; and the data packet proportion of the SMS communication component is 20%. That is, the data packets in the shared send queue are divided into three parts according to the respective proportions, and the three parts are respectively sent to the server through the three communication components. Each network channel has a certain packet loss rate; thus, a certain amount of redundancy can be set for the data packets transmitted by each network channel. A higher data redundancy can be set for the server communication component corresponding to the network channel with a higher packet loss rate, thereby improving the reliability of the data transmission.

The data packet proportions and the redundancies of the at least two network channels may be set according to actual conditions, which are described in the foregoing examples and are not specifically limited here.

In some embodiments, the data transmission performance of each network channel and the data volume of the IoT data may vary in real time. Therefore, the data transmission performance of each network channel may be monitored in real time, to adjust the data proportions of the at least two network channels. Therefore, in one embodiment, the processing component (101) may further be configured to monitor the data transmission performance of the network channels corresponding to the at least two server communication components in the process of sending data packets. If the data transmission performance is changed, the data packet proportions of the at least two server communication components (102) are adjusted.

The processing component (101) sending the data packets in the shared send queue to the server through the at least two server communication components (102) according to the respective data packet proportions may comprise continuously sending the data packets in the shared send queue to the server through the at least two server communication components (102) according to the respective adjusted data packet proportions.

To ensure that the data packet proportion of each network channel enables the corresponding network channel to achieve its optimal data transmission capability, a preset threshold may be set corresponding to the data transmission performance of each network channel. When the data transmission performance meets the preset threshold, it can be considered that the network has a good data transmission capability, and when the data transmission performance is lower than the preset threshold, then it is indicated that the data transmission capability of the network is poor. In some embodiments, the preset threshold of each network channel may be set to the same value, and a different preset threshold may also be set for each network channel according to different transmission requirements. The setting can be made according to actual conditions and is not specifically limited herein.

In some embodiments, a network parameter of each network may also be adjusted while adjusting the data packet proportion of the network channel. For example, when the external interference subjected by the LoRa network increases, a spreading factor of the LoRa communication component may be adjusted to further improve the anti-interference performance of the LoRa network channel. For example, when congestion occurs in the mobile communication network channel, the Quality of Service (QoS) of the mobile communication component may be lowered to reduce the volume of data transmitted by the mobile communication network channel. If the mobile communication network is in good condition, the QoS may be enhanced to ensure the stability and reliability of the communication quality. The network parameter adjustment of each network channel is not exemplified here and may be set specifically according to actual acquirements.

In some embodiments, when it is detected that the data transmission performance is changed, the processing component (101) adjusting the data packet proportions of the at least two server communication components (102) may comprise: determining whether the data transmission performance of each of the at least two network channels is greater than a preset threshold; if the data transmission performance of any network channel is greater than or equal to the preset threshold, determining whether the volume of data transmitted by the any network channel is smaller than a first transmission threshold; if the data volume is less than the first transmission threshold, improving the data packet proportion of the any network channel; if the data transmission performance of the any network channel is less than the preset threshold, determining whether the volume of data transmitted by the any network channel is greater than a second transmission threshold; and if the data volume is greater than the second transmission threshold, reducing the data packet proportion of the any network channel.

In some embodiments, the network bandwidth of each network channel is actually fixed. When the data transmission performance of any network channel reaches the preset threshold, the transmission capability of the any network channel may be used as the first transmission threshold. The first transmission threshold is used to represent the current maximum data transmission capacity of any network channel. If the actual volume of data transmitted by any network channel is less than the first transmission threshold, a data packet proportion of the network channel may be further increased until the volume of data transmitted by the network channel reaches the first threshold, thus achieving full utilization of the transmission capability of the network channel.

However, if the data transmission performance of any network channel is lower than the preset threshold, the data transmission capability of the network channel is considered to be poor. Therefore, a lower limit transmission threshold may be set as the second transmission threshold, and the lower limit transmission threshold may be 0, i.e., it is indicated that the network channel is abandoned when the data transmission performance is lower than the preset threshold, so that the data packet proportion is 0. In some embodiments, according to the actual situation, if the data transmission performance of each network channel is relatively poor, the volume of transmitted data corresponding to the lowest packet loss rate of the any network channel may be set as the lower limit threshold, so as to ensure the reliability and stability of the any network channel.

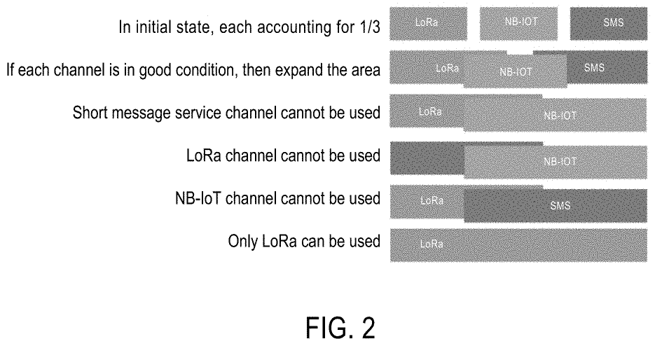

FIG. 2 is a diagram illustrating adjustment of data packet proportions of at least two network channels according to some embodiments of the disclosure. The respective network channels corresponding to the at least two server communication components (102) selected by the gateway may include a LoRa network channel, an NB-IoT network channel, and an SMS network channel. An initial data packet proportion of each network channel is set to ⅓. That is, if 300 data packets exist in a send queue, then each network channel transmits 100 data packets. The data transmission performance of various network channels is monitored simultaneously; the data packet proportion of a network channel with a low packet loss rate is increased; and the data packet proportion of a network channel with a high packet loss rate is reduced until the network channel with a high packet loss rate is abandoned.

In some embodiments, there may be a surge in the data volume of the IoT data, and this surge may result in a corresponding network channel becoming unavailable due to paralysis of a certain network. In this case, the data transmission capacity of the selected network channels cannot meet the actual communication requirements, and at least two server communication components may be reselected from the plurality of server communication components (102) so that the data transmission capacity of network channels corresponding to the reselected at least two server communication components meets the transmission requirement of the surged data volume of the IoT data. In one embodiment, the processing component (101) may further be configured to monitor the data transmission performance of the at least two network channels in the process of sending data packets; if the data transmission performance is changed, determine whether the current data transmission capacity of the at least two network channels is less than the data volume of data packets in the shared send queue; and if yes, reselect at least two server communication components from the plurality of server communication components and determine data packet proportions of the reselected at least two server communication components.

The processing component (101) sending the data packets in the shared send queue to the server through the at least two server communication components (102) according to the respective data packet proportions may comprise sending the data packets in the shared send queue to the server through at least two reselected server communication components (102) according to respective data packet proportions.

In some embodiments, if the data volume of the transmitted IoT data plummets and the network transmission performance changes, the server communication components may be reselected, and the IoT data is transmitted with the least quantity of network channels to reduce the data processing capacity of the server.

For example, when the mobile communication network is good, the combination of the mobile communication component and the LoRa communication component may be reselected; when the mobile communication network is paralyzed, the combination of the LoRa communication component and the NB-IoT communication component may be reselected; and when the LoRa network is seriously and simultaneously degraded, the combination of the NB-IoT communication component and the SMS communication component combination may be reselected.

Due to the limited data capacity of the network channel, consideration is taken for minimizing unnecessary data transmission as much as possible. Therefore, the processing component (101) caching the at least one data packet into the send queue may specifically set a serial number for each data packet in an ascending order according to an encoding order of the at least one data packet, and caching the at least one data packet sequentially into the shared send queue according to an ascending order of the serial number.

By setting the serial number for each data packet, the operation of the server generating a receiving response for each data packet can be avoided. Instead, the server can determine a serial number of an unreceived data packet according to the serial number of the data packet, to generate and send a retransmission request to the first gateway. Therefore, the first gateway only needs to retransmit the data packet that is not received by the second gateway, as described specifically below.

In one embodiment, the processing component (101) sending the data packets in the shared send queue to the server through the at least two server communication components (102) according to the respective data packet proportions may specifically include: determining serial numbers of data packets respectively corresponding to the at least two server communication components (102) according to respective corresponding data proportions; acquiring the data packets in the shared send queue sequentially; and sending the data packets in the shared send queue to the server respectively through the at least two server communication components (102) according to the respective corresponding serial numbers.

Serial numbers are set for the data packets in the shared send queue. Thus the serial numbers of the respective corresponding data packets of each network channel are determined according to the data packet proportion of each network channel. As one example, there may be 300 data packets numbered as 1 to 300 in the send queue. If the data packet proportion of each network channel is 100%, then the serial numbers of the data packets corresponding to each network channel are 1 to 300. If the at least two server communication components (102) include the NB-IoT communication component (1024) and the LoRa communication component (1025), the data packet proportions thereof are correspondingly 60% and 40%, respectively. Then, it can be determined that the serial numbers of the data packets corresponding to the NB-IoT communication component (1024) may be 1 to 180, and the serial numbers of the data packets corresponding to the LoRa communication component may be 181 to 300. In some embodiments, the foregoing is only an example formatting of the serial numbers. If a certain redundancy is also set, serial numbers corresponding to redundant data packets may further be determined according to the magnitude of the redundancy, which may be specifically set according to actual conditions, and is not specifically limited herein.

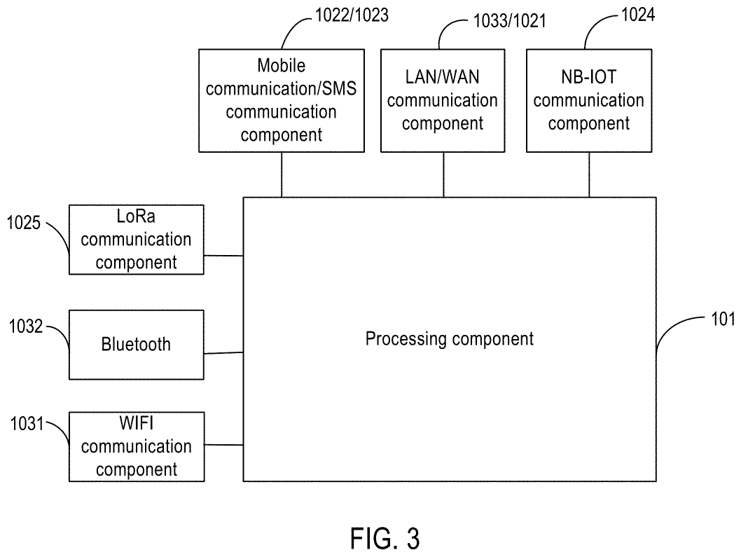

FIG. 3 is a block diagram of an embodiment of a gateway according to some embodiments of the disclosure. In addition to the processing component (101) and the plurality of server communication components (102) in the embodiment of FIG. 1, the gateway may further include at least one terminal communication component (103) connected to the processing component. The terminal communication component (103) each supports a different network protocol.

The terminal communication component (103) is each configured to establish network connections with a plurality of IoT terminals based on respective corresponding network protocols.

The processing component (101) is further configured to perform IoT data communication with an IoT terminal through any terminal communication component (103).

The processing component is further configured to receive IoT data sent by the IoT terminal through the respective corresponding terminal communication component (103) and perform corresponding service processing based on the IoT data.

The IoT terminal may be any terminal device with a gateway access capability according to a different application scenario. For example, in a ticket verification application scenario, the IoT terminal may comprise a Personal Digital Assistant (PDA), a ticket gate, a ticketing terminal, a ticket collecting terminal, etc. The gateway establishes network connections with a plurality of terminal devices, and a plurality of network channels are established through the plurality of server communication components of the gateway based on different network protocols, thereby forming an IoT application scenario that can realize IoT data synchronization services between the IoT terminals through remote communication.

In one embodiment, the IoT terminal may further be an image collecting device disposed in an area where each ticket gate is located. A plurality of image collecting terminals send IoT data (e.g., collected image information) to the interconnected gateway and may perform image processing on the IoT data through the processing component (101) of the gateway, thus implementing the edge computing capability of a local end of the gateway. For example, by processing the image information collected by the image collecting terminals, human traffic statistics are performed on the crowd flow of people passing through the ticket gate. These statistics are sent to the server through at least two server communication components to assist the server in performing corresponding service processing. Not only is the existing computing power of the gateway fully utilized to implement the local edge computing service processing, but also, the data processing burden of the server is reduced to thereby further improve service processing efficiency.

In one embodiment, the terminal communication module (103) may include one or more communication components selected from the group consisting of a Wi-Fi communication component (1031), a Bluetooth communication component (1032), and a LAN communication component (1033).

In some embodiments, any IoT terminal device can establish a network connection with the gateway through any of the terminal communication components (103), thereby forming a plurality of IoT LANs.

To enable the IoT device to have the IoT capability without hardware modification or with minimum hardware modification, the gateway in one embodiment provides a wireless accessing method by providing the Wi-Fi communication component (1031), the Bluetooth communication component (1032), and the like. The LAN communication component (1033) can provide a wired accessing method and provides a LAN accessing service for the IoT terminal through network cable accessing.

In one embodiment, the server communication components are further configured to establish network connections with a plurality of IoT terminals based on the corresponding network protocols.

The processing component is further configured to perform IoT data communication with at least one IoT terminal through any server communication component.

In some embodiments, the plurality of server communication components may include server communication components for connecting the IoT terminals, e.g., a LoRa communication component, an ad hoc communication component, and the like.

The LoRa communication component (1025) may also be configured to establish network connections with the plurality of IoT terminals based on the corresponding network protocols.

The processing component may also be configured to perform IoT data communication with the at least one IoT terminal through the LoRa communication component (1025).

Therefore, the LoRa communication component (1025) can not only provide a remote communication service to the gateway by establishing a network connection with the server, but also provide a LAN access service to the IoT terminal installed with the LoRa communication component.

In some embodiments, the IoT terminal may access a different LAN through any terminal communication component or server communication component according to actual requirements, which is not specifically limited herein.

The processing component (101) is further configured to receive first IoT data through any terminal communication component (103) connected to a first IoT terminal and control the at least two server communication components to send the first IoT data to the server.

In some embodiments, the processing component (101) may implement IoT data communication between the IoT terminal and the server through at least two server communication components (102) and at least one terminal communication component (103). In one embodiment, when the IoT terminal needs to send the IoT data to the server for corresponding service processing, the processing component (101) may further be configured to receive first IoT data through any terminal communication component (103) connected to the first IoT terminal and control the at least two server communication components (102) to send the first IoT data to the server.

In one embodiment, the server needs to deliver IoT data or a control instruction to the IoT terminal, so as to implement data synchronization of the IoT terminal or implement cloud management and control on the IoT terminal. The processing component (101) may further be configured to receive, through the at least two server communication components, second IoT data sent by the server, and control any terminal communication component (103) connected to the first IoT terminal to send the second IoT data to the first IoT terminal.

The gateway can access a plurality of networks through a plurality of server communication components (102) and establish connections with the server respectively based on different network protocols, thereby establishing a plurality of network channels between any two gateways to implement remote communication. In some embodiments, according to different access networks, the server communication component (102) may be classified into accessing a non-self-organizing network built by a network operator, such as an Ethernet/mobile communication network, a SMS network, and a NB-IoT network; or accessing a self-organizing network, such as a LoRa network and an ad hoc (point-to-point) network, which is not limited herein.

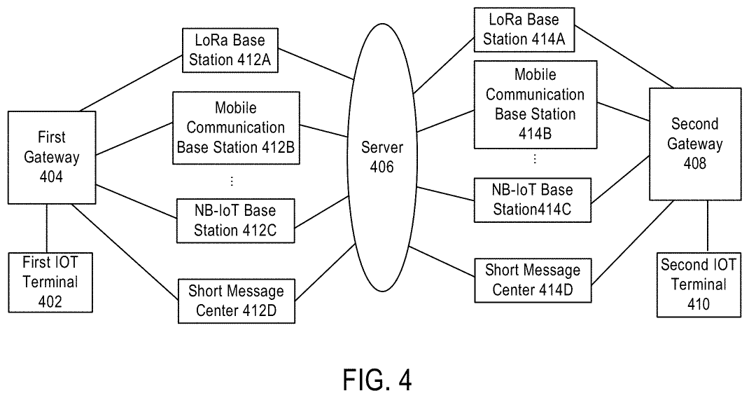

FIG. 4 is a block diagram of a plurality of network channels established by a first gateway and a second gateway based on different network protocols. The gateway (404) in FIG. 4, whether accessing a self-organizing network (e.g., 412a, 414a) or a non-self-organizing network (e.g., 412b, 414b), establishes a network connection with a server (406), and can determine, through the server (406), a network connection between the second gateway (408) connected to a second IoT terminal (410) and the server (406), so as to send first IoT communication data to the second gateway (408).

The self-organizing network base station (e.g., 412a, 412b) can have a certain management and control capability, and can store association relationships between IoT terminals (402, 410) to implement the capability of forwarding IoT data. Therefore, when the self-organizing network is not required to or cannot be connected to the server (406), the gateway (404) only needs to establish a network connection with the self-organizing network base station respectively to establish a corresponding self-organizing network channel.

In one embodiment, the plurality of server communication components (412a, 412b, 412c, 412d and 414a, 414b, 414c, 414d) may include a self-organizing network communication component. The self-organizing network communication component may be the LoRa communication component (412a, 412b).

The self-organizing network communication component is configured to establish a network connection with the self-organizing network base station based on a self-organizing network protocol.

A processing component (101) is further configured to select the self-organizing network communication component, and perform IoT data communication with the self-organizing network base station through the self-organizing network communication component.

The self-organizing network base station can establish a network connection to implement mutual communication without connecting to the server (406), and the IoT communication data does not require the server (406) to perform service processing. In this case, a self-organizing network channel between the first gateway (404) and the second gateway (408) can be formed only through interconnection between the self-organizing network base stations.

For example, the LoRa network channel is a self-organizing network channel. The first gateway (404) can establish a network connection with a LoRa base station (412a) through the LoRa communication component (1025) based on a LoRa network protocol, and the second gateway (408) can establish a network connection with the LoRa base station (414a) based on the LoRa network protocol, thereby forming the LoRa network channel between the first gateway and the second gateway.

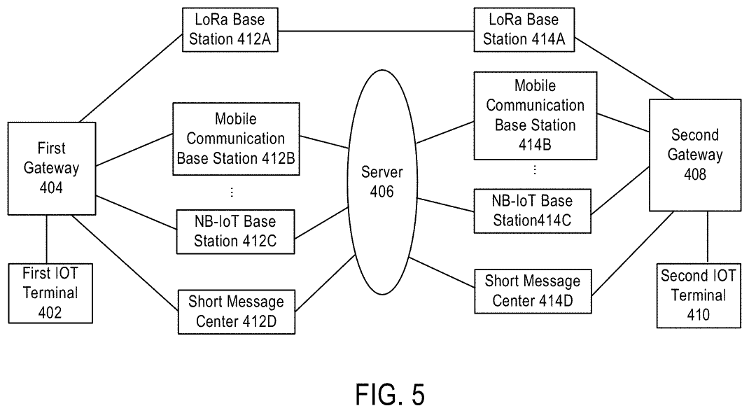

FIG. 5 is another schematic diagram of a plurality of network channels established by a first gateway and a second gateway based on different network protocols. The self-organizing network LoRa base stations (412a, 412b) are interconnected and establish network connections with the gateway devices (404, 408) through the LoRa base stations (412a, 412b) to form self-organizing network channels. The non-self-organizing network needs to establish network connections with the server respectively through the gateway devices to implement the respective corresponding non-self-organizing network channels.

The processing component (101) is further configured to perform protocol conversion on a communication protocol of the IoT data transmitted between any terminal communication component (103) and at least two server communication components (102).

In one embodiment, the processing component implements IoT data communication between the LAN and the WAN by performing protocol conversion on the communication protocol of the IoT data transmitted between any terminal communication component (103) and at least two server communication components (102). In particular, as an optional implementation, the at least two server communication components may include the NB-IoT communication component (1024), and any terminal communication component connected to the first IoT terminal may include the LoRa communication component (1033).

The processing component may be configured to perform protocol conversion on a communication protocol of the IoT data transmitted between any terminal communication component (103) and the at least two server communication components (102), and specifically, may perform protocol conversion on the communication protocol of the IoT data transmitted between the NB-IoT communication component and the LoRa communication component.

The communication protocol conversion based on the processing component can not only realize IoT data communication between the server and the IoT terminal device but also realize IoT data communication between IoT terminals accessing different networks. For example, a third IoT terminal accesses the gateway through the Wi-Fi communication component, a fourth IoT terminal accesses the gateway through the LoRa communication component, and the processing component converts the communication protocol of the IoT data sent by the third IoT terminal into the LoRa communication protocol, thus achieving communication with the fourth IoT terminal. Therefore, the processing component can further implement data communication between LAN IoT terminals by realizing the conversion of different communication protocols between the terminal communication components (103).

In some embodiments, the IoT data sent by the processing component (101) to the server may be generated by the IoT terminal interconnected to the gateway and then sent to the processing component (101) through the corresponding terminal communication component (103). It is also possible that the processing component (101) performs IoT service processing based on the local edge computing capability to generate service data and sends the service data to the server.

Therefore, the IoT data sent by the processing component (101) to the IoT terminal may also be sent to the processing component (101) by the server through network channels formed by connections with the at least two server communication components (102) and sent by the processing component (101) to the IoT terminal. It is also possible that the processing component (102) performs IoT service processing based on the local edge computing capability to generate service data and sends the service data to the IoT terminal.

In one embodiment, the processing component performs protocol conversion on the communication protocol of the IoT data and can establish a network connection between the IoT terminal connected to the at least one terminal communication component and the server. By selecting the network channel, mutual cooperation between the NB-IoT communication component (412c, 414c), the LoRa communication component (412a, 414a), the mobile communication (412b, 414b) and SMS communication component (412d, 414d), and the WAN communication component is implemented to perform IoT data communication between the IoT terminal and the server. In this way the influence of the external environment on the device communication can be well resisted, thus achieving stable and reliable data transmission between devices and improving the communication quality of IoT data communication in the IoT field.

As can be seen from the embodiment of FIG. 1, the IoT data sent by the processing component (101) to the server comprises data packets obtained by encoding the IoT data, and serial numbers of the data packets are set according to the encoding order. Therefore, the IoT data sent by the server to the processing component also exists in the form of data packets, and the data packets received by the processing component through the at least two server communication components (102) are pre-cached into the shared receive queue.

In some embodiments, the processing component (101) receives, through the at least two server communication components (102), the second IoT data sent by the server by: receiving at least one data packet sent by the server respectively through the at least two network channels, wherein the at least one data packet is obtained by encoding the second IoT data based on a preset encoding protocol; performing a deduplication processing on the at least one data packet based on a serial number of each data packet, and sequentially caching the data packets obtained after the deduplication into the shared receive queue according to an ascending order of serial numbers of the data packets; and sequentially decoding the data packets in the shared receive queue according to a preset decoding protocol to obtain the second IoT data.

The at least two network channels cooperate to perform data packet transmission, thus to ensure the data arrival rate, not only a certain data packet redundancy is set, but also a repeated transmission of the same data packet may exist, for example, when the network proportion of each network channel is 100%. As a result, the data packet sent by the at least two server communication components (102) and received by the processing component (101) may be received repeatedly. Therefore, the deduplication of the service data is required, and the deduplication processing is performed on the data packets having the same serial number based on the serial number of each data packet, thereby avoiding an increase of the traffic of the first IoT by repeated sending of the second IoT data to the first IoT terminal.

After the received at least one data packet is deduplicated and sorted, the at least one data packet is sequentially cached into the receive queue, and at least one data packet in the receive queue is decoded by a decoder and then decompressed and decrypted or the like, so as to obtain the second IoT data.

However, in the data transmission process, packet loss still occurs. After performing deduplication processing on the at least one data packet based on the serial number of each data packet, and sequentially caching the data packets obtained after the deduplication to the receive queue in an ascending order of serial numbers of the data packets, the processing component (101) may further be configured to: detect a serial number of an unreceived data packet, generate a retransmission request based on the serial number of the unreceived data packet and send the retransmission request to the server, and receive a data packet resent by the server for the retransmission request.

The serial number of the unreceived data packet is detected based on the serial number of the at least one data packet cached in the shared receive queue. For example, it is detected that only serial numbers 1, 3, and 4 are received, so it can be determined that a data packet with a serial number 2 is lost and not received. In this case, a retransmission request for the packet with the serial number 2 can be generated and sent to the server. In some embodiments, it can be understood that when the serial number of the data packet is set, a start identifier and an end identifier are set at the same time, and therefore, the server can determine the total quantity of the at least one data packet based on the start identifier and the end identifier. However, if the data packet corresponding to the start identifier or the end identifier is lost, resending of the data packet corresponding to the start identifier or the end identifier can be requested first, and it is further determined whether a lost data packet still exists according to the start identifier and the end identifier, which is not specifically limited herein.

However, the processing component (101) may further be configured to receive a retransmission request sent by the server, wherein a serial number of the unreceived data packet is carried in the retransmission request.

The processing component (101) is further configured to cache a data packet corresponding to the serial number of the unreceived data packet into the shared retransmission queue and to send the data packet in the shared retransmission queue to the server through the at least one network channel.

In some embodiments, after the processing component (101) obtains the second IoT data, the second IoT data further needs to be converted into a communication protocol corresponding to the terminal communication component (103) accessed by the first IoT terminal. That is, if the first IoT terminal is accessed via Bluetooth, the second IoT data needs to be converted to the Bluetooth communication protocol and sent to the first IoT terminal. If the Wi-Fi or the network cable is used, the second IoT data also needs to be converted into a corresponding communication protocol for transmission, which has been described in detail in the foregoing, and is not repeated herein.

In one embodiment, a Wi-Fi power amplifying component may further be included in one embodiment to increase the coverage radius of the Wi-Fi communication component, so that more Wi-Fi terminals can be accessed.

Similarly, a LoRa power amplifying component may further be included to increase the coverage radius of the LoRa communication component, so that more LoRa terminals can be accessed.

When no server accesses the self-organizing network, as an optional implementation, the processing component may further be configured to receive, through a self-organizing network communication component, third IoT data sent by a self-organizing network base station.

The processing component (101) receiving, through the self-organizing network communication component, the IoT data sent by the self-organizing network base station may comprise receiving the third IoT data of the self-organizing network base station through the self-organizing network communication component.

In one embodiment, the processing component performs deduplication and decoding processing on at least one data packet sent by the server, thus obtaining the second IoT data. Different from the prior art which requires sending an acknowledgment frame data packet to the server for each received data packet, in this embodiment of the disclosure, the lost data packet is determined according to the serial number of the data packet, and only the retransmission request is sent to the gateway so that the gateway retransmits the lost data packet, which can not only effectively reduce unnecessary data transmission and reduce the network load, but also ensure the integrity of the second IoT data, improve data transmission efficiency, and greatly improve communication quality.

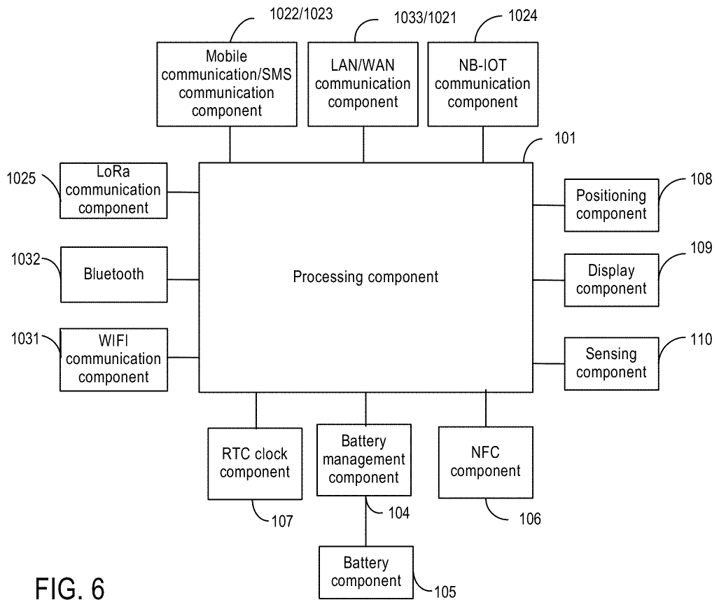

FIG. 6 is a block diagram of a gateway according to some embodiments of the disclosure. In addition to the processing component (101), the plurality of server communication components (102), and the terminal communication component (103) described in the embodiments shown in FIG. 1 and FIG. 3, the gateway in one embodiment may further include a battery component (104) connected to the processing component; a battery management component (105) connected to the processing component (101) and the battery component (104) respectively; and an NFC component (106) connected to the processing component (101), an real-time clock (RTC) component (107) connected to the processing component (101), a positioning component (108) connected to the processing component (101), a display component (109) connected to the processing component, and at least one sensing component (110) connected to the processing component.

The battery component (104) may be any existing built-in battery, such as a lithium battery. The lithium battery supplies power to various functional components of the gateway, thus capable of ensuring that normal operations of the various components can still be maintained when the gateway cannot be connected to an external power supply. As such, the gateway can provide services in a scenario of an environment inconvenient to connect to the external power supply, and the mobile gateway deployment can be implemented. This technical solution is not only convenient for the expansion of the IoT gateway, but it is also applicable to the deployment of more complicated IoT application scenarios.

The battery management module (105) is configured to acquire electric quantity information of the battery component, wherein the electric quantity information implements charge and discharge management of the battery component.

The NFC component (106) is configured to store networking information of the at least one terminal communication component (103), and after an interconnection request for any terminal communication component (103) sent by any IoT terminal within a preset distance is received, send networking information of the any terminal communication component (103) to the any IoT terminal.

The Near Field Communication (NFC) component has near field communication characteristics; thus, the IoT terminal having the NFC function needs to perform NFC communication with the gateway device within a preset communication distance. The IoT terminal acquires, based on a preset communication key, networking information of at least one terminal communication component (103) stored in the NFC component (106), thereby enabling the IoT terminal to implement fast networking with the gateway based on the acquired networking information.

In one embodiment, the NFC component (106) may also store device-related information, and at the same time, may perform corresponding service processing with the IoT terminal having the NFC function based on the device-related information.

In one embodiment, the time initialization caused by the power-off or failure of the gateway is avoided, and the RTC clock component (107) is disposed to provide time information for the processing component. The RTC clock component has an independent power supply. Even if the gateway is powered off or failed, timing is still performed to ensure the accuracy of the real-time clock to ensure that the processing component (101) performs service processing on the time-sensitive IoT data.

In one embodiment, the positioning component (108) is configured to receive a positioning instruction sent by the processing component (101), and collect current location information based on the positioning instruction and send the current location information to the processing component (101).

The processing component (101) is configured to control the positioning component (108) to collect current location information and send the current location information to the server through the at least two server communication components (102).

The server can locate each gateway based on the positioning information sent by the gateway and real-time monitoring of the various gateways can also be achieved when the network deployment architecture in the IoT can be known in real-time.

In some embodiments, the positioning component (108) may be any positioning device such as a global positioning system (GPS) or BeiDou Navigation Satellite System (BDS), which is not specifically limited herein.

In some embodiments, the processing component (101) is further configured to acquire working state information of each IoT terminal through the at least one terminal communication component (103) and control the display component (109) to display the working state information.

The working state information may include, for each IoT terminal, networking information, electric quantity information, abnormal state, location information, and the like.

The display component (109) is configured to output the working state information on a display screen. The display component (109) can output the working state information of the IoT terminal in the display screen so that that staff can monitor working states of various IoT terminals based on the information displayed in the display screen.

In some embodiments, the display component (109) can also obtain the device information stored in the NFC component (106) through the processing component (101), and output the device information of the gateway through the display screen so that staff can conveniently read the device information of the gateway. The sensing component (110) is configured to collect environmental information in the surrounding environment. In some embodiments, the sensing component (110) may include a temperature sensor and a humidity sensor. The temperature sensor and the humidity sensor can be used to collect the temperature information and the humidity information of the external environment and send the temperature information and the humidity information to the processing component (101).

The processing component (101) can implement network selection service processing based on the temperature information and the humidity information. It can also control the display component to display the temperature information and the humidity information, so that staff conveniently interpret and acquire the working environment information of the gateway.

In some embodiments, it can be understood that the gateway in one embodiment may further include an indicator component configured to indicate the working state of the gateway, and alarm prompt information may be output when an abnormality occurs in the gateway or the IoT terminal.

In addition, an information input component, e.g., an input device such as a button and a touch screen may further be included and staff can input control information through the information input component.

The gateway may also include a DC power supply component to support the input of an external DC power supply. The DC power supply component can be configured not only to supply power to the battery component but also to supply power to other components of the gateway when connected to the external DC power supply.

In one embodiment, a voltage stabilizing component configured to stabilize the input voltage of each component is further included to ensure the stability of the operation of each component.

It can be understood that the gateway in one embodiment includes, but is not limited to, the above functional components, and may also include any other functional component to implement more service processing functions, which is not specifically limited herein, and may be set according to actual conditions.

The gateway device provided by one embodiment provides a plurality of functional components for assisting the processing component with performing related service processing so as to further improve gateway functionality and to provide more application scenarios for the gateway of the IoT, thus being more universal and multi-functional.

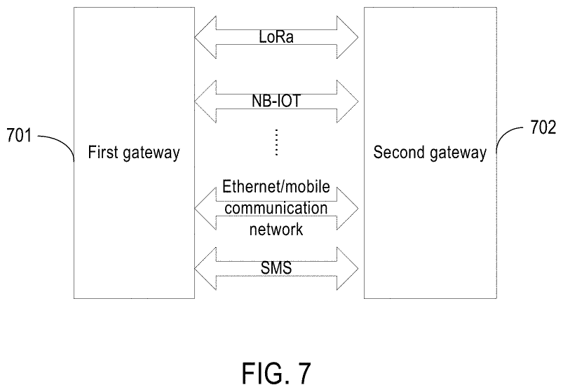

FIG. 7 is a block diagram of an embodiment of a data communication system according to some embodiments the disclosure. The system may include a plurality of gateways as described in the foregoing embodiments of FIG. 1 to FIG. 6 deployed in the same venue area, and a plurality of network channels are established between any two gateways based on different network protocols.

A first gateway (701) is configured to send IoT data to a second gateway (702) through at least two network channels.

The first gateway (701) sending the IoT data to the second gateway (702) through the at least two network channels may comprise selecting at least two network channels from the plurality of network channels established based on the different network protocols, and sending the IoT data to the second gateway (702) through the at least two network channels.

The second gateway (702) may be configured to receive, through the at least two network channels, the IoT data sent by the first gateway (701).

As can be seen from the foregoing, the plurality of server communication components (102) of the gateway each support different network protocols, thus a plurality of network channels based on the different network protocols can be established correspondingly between a plurality of server communication components in the first gateway (701) and a plurality of server communication components in the second gateway. Therefore, the first gateway (701) and the second gateway (702) can perform IoT data communication based on at least two network channels in the plurality of network channels. The at least two network channels are determined by the processing component of the first gateway (701) by selecting at least two server communication components.

In some embodiments, the server communication components of each gateway may include a WAN communication component (1021), a mobile communication component (1022), an SMS communication component (1023), an NB-IoT communication component (1024), and a LoRa communication component (1025). Thus, an Ethernet network channel, a mobile communication network channel, an SMS network channel, an NB-IoT network channel, and a LoRa network channel can be established between the first gateway (701) and the second gateway (702) based on the corresponding network protocols.

Therefore, the first gateway (701) and the second gateway (702) can perform IoT data communication through the at least two network channels.

The specific implementations of the embodiments of the disclosure have been described in detail in the foregoing, and will not be repeated herein.

With the data communication system provided in one embodiment the problem where data communication between devices is affected due to network channel paralysis or congestion during data communication using only one network channel can be avoided, thereby affecting the actual service processing. With the aforementioned data communication system, the foundation is established for achieving higher communication efficiency and communication quality by implementing data communication between the devices cooperatively through at least two network channels.

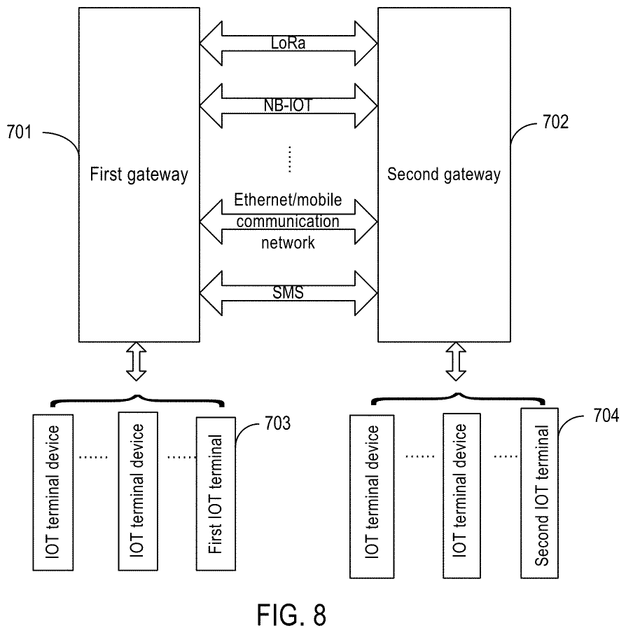

FIG. 8 is a block diagram of an embodiment of a data communication system according to the disclosure. The system may further include at least one IoT terminal connected to each gateway, wherein the at least one IoT terminal and the plurality of gateways are deployed in the same venue area.

The first gateway (701) is further configured to receive first IoT data sent by the first IoT terminal (703).

The second gateway (702) is further configured to determine a second IoT terminal (704) associated with the first IoT terminal (703) and send the IoT data to the second IoT terminal (704).

The second IoT terminal (704) is configured to perform data synchronization based on the IoT data.

In one embodiment, the first gateway (701) may further be configured to cache the IoT data sent by the first IoT terminal into a shared send queue.

The first gateway (701) sending the IoT data to the second gateway (702) through the at least two network channels may comprise sending the IoT data in the shared send queue to the second gateway (702) through the at least two network channels.

The specific implementations of the embodiments of the disclosure have been described in detail in the foregoing, and will not be repeated herein.

As can be seen from the foregoing, the IoT terminal can access the gateway through the terminal communication component, and the terminal communication component may include a Bluetooth communication component, a LAN communication component, and a Wi-Fi communication component. When the IoT terminal is configured with a LoRa module, the gateway can also be accessed through a LoRa communication component.

Usually, to minimize the transformation of the IoT terminal and reduce the device cost, the IoT terminal can access the gateway via wireless Wi-Fi. The Wi-Fi has a strong terminal accessing capability and does not need to be deployed with network cables; therefore, it is applicable in a multi-terminal application scenario.

In a ticket application scenario, the IoT terminal may be a plurality of ticket gates, PDAs, and the like distributed at various doorways of a venue. To ensure that the gateway can meet the actual service requirements, the data transmission performance of the Wi-Fi communication component of the gateway can be measured in advance.

In some embodiments, to improve the signal strength of the Wi-Fi communication component, a power amplifying module is also added to improve the terminal connection capability of the Wi-Fi communication component. Table 1 shows the signal receiving strength of Wi-Fi communication components of the first gateway and the second gateway at different distances tested according to a preset signal power.

TABLE 1

| | | |
|---|---|---|
| Distance | First gateway | Second gateway |

| | | | |
|---|---|---|---|
| 1 | m | −30 dBm | −31 dBm |
| 2 | m | −32 dBm | −35 dBm |
| 4 | m | −40 dBm | −40 dBm |
| 6 | m | −45 dBm | −43 dBm |
| 8 | m | −50 dBm | −49 dBm |
| 10 | m | −50 dBm | −51 dBm |
| 12 | m | −53 dBm | −52 dBm |

Based on a link loss formula of a WIF signal, the following can be known:

when the Wi-Fi signal is at 2400 MHz: the link loss value Lbf=100+20lgD;

when the Wi-Fi signal is at 5800 MHz: the link loss value Lbf=(108)+20lgD;

wherein D represents the distance, and Lbf represents a link loss value at different distances in the free space.

It can be seen from Table 1 that the strength of the signal received at 1 m is −30 dBm, the strength at 10 m is −50 dBm, and the strength difference is 20, which is similar to the calculation of the above link loss formula. Therefore, it can be inferred that the difference between the strength at 100 m and the strength at 10 m is 20 dBm, that is, the strength at 100 m is approximately −70 dBm, which can meet the actual access need of IoT terminals.

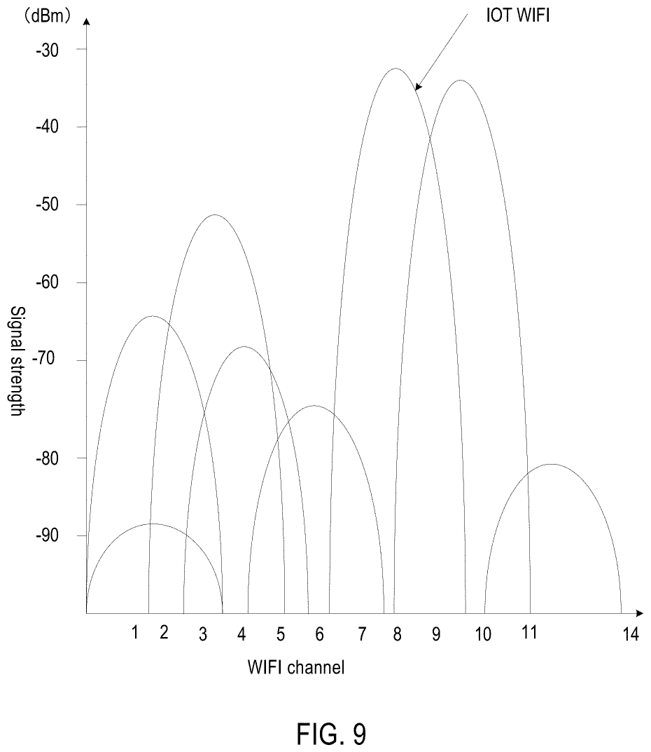

FIG. 9 shows results of testing and analyzing Wi-Fi signals in a certain venue area. In some embodiments, the strength of the Wi-Fi signal only represents the signal, and a Wi-Fi power method component can only improve the strength of the Wi-Fi signal. A strong Wi-Fi signal does not suggest high data transmission performance thereof, whereas a weak Wi-Fi signal definitely suggests poor data transmission performance thereof. This is because the Wi-Fi communication component is highly susceptible to interference from other devices in the same frequency band in the working process, thus it is necessary to avoid setting the frequency band of the Wi-Fi signal in a crowded frequency band as much as possible. In FIG. 9, the frequency band of the Wi-Fi signal is divided into channels 0-14 to facilitate understanding. As can be seen from the figure, a large number of Wi-Fi hotspots work around a Wi-Fi channel 4. Therefore, to avoid interference from other devices and improve the data transmission performance of the Wi-Fi communication component, the signal frequency band of the Wi-Fi communication component of the gateway may be set to approximately channels 8-14. As shown in the figure, the signal frequency band of the Wi-Fi communication component (IoT-Wi-Fi) of the gateway is set to approximately channel 8, and the data transmission performance of the Wi-Fi communication component can be effectively improved.

In addition, since the LoRa network channel is a self-organizing network channel built by a non-operator, the signal coverage performance of a LoRa communication component needs to be pretested, such that the data transmission performance of the LoRa network channel deployed in the venue area can meet the actual IoT service processing requirements.

The preset signal strength adopted by the LoRa communication component in one embodiment can achieve an effective communication distance of 8 KM (kilometers) in the urban area. The receiving sensitivity thereof can reach −148 dBm. Since the LoRa signal operates in the frequency band of 433 MHz, based on the link loss formula: Lbf=85+20lgD, wherein D represents the distance, and Lbf represents the link loss of the LoRa signal at the distance D in the free space. However, the signal will be affected by factors such as a building and a glass-steel frame structure, the actual link loss will be larger; therefore, a link loss budget that can be provided by the LoRa communication component provided in the implementation example of the disclosure reaches 178 dB. The packet loss rate is an important indicator of the data transmission performance of the network channel. To ensure data transmission performance thereof meets the actual service requirements, testing is performed on the packet loss rate of the LoRa network channel established between the first gateway and the second gateway based on the LoRa communication component in different application scenarios.

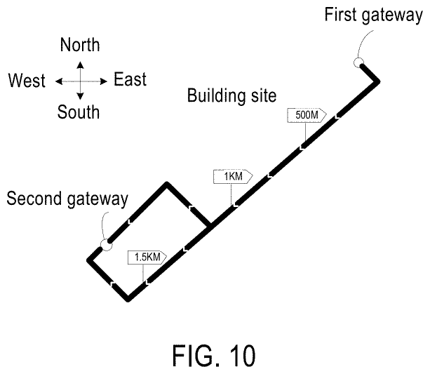

FIG. 10 shows a signal coverage test of a LoRa network deployed in a building site. The building site is constructed using a special steel structure, thus having a certain impact on wireless signal transmission. To test the actual transmission performance of the LoRa network channel, the first gateway (701) is deployed at the north gate of the building site; the second gateway is deployed at the south gate of the building site; and IoT terminals access the gateways through Wi-Fi signals. An actual communication distance from the south gate to the north gate is 1.5 KM. The ticket checking speed of the first IoT terminal is slow, for example, one ticket every 1-2 seconds, and no packet loss occurs in the actual test, that is, the arrival rate is 100%.

If a stress test is added, the first IoT terminal sends 44 pieces of ticket data through the first gateway, the second gateway receives 33 pieces of ticket data, and the arrival rate is 75%. The second IoT terminal sends 66 pieces of ticket data through the second gateway, the first gateway received 54 pieces of ticket data, and the arrival rate reaches 81.8%.

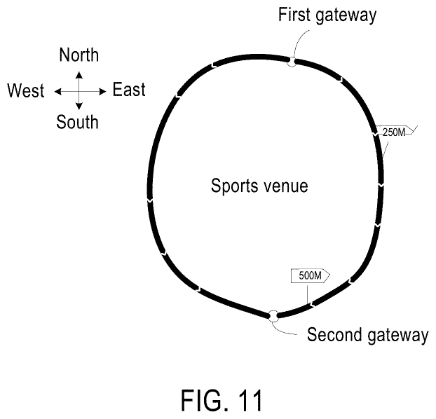

To reduce the packet loss rate, further testing is done. As shown in FIG. 11, it is a signal coverage test of a LoRa network deployed in a sports venue. The sports venue has less obstructions such that the building environment has less impact on the signal. The first gateway (701) is deployed at the north gate of the building site, the second gateway (702) is deployed at the south gate of the building site, and IoT terminals access the gateways through Wi-Fi signals.

It is found through the actual test that the signal strength of the LoRa communication component is obviously affected by the distance of the gateway from the ground. After the gateway height is reduced in the actual test, a first IoT terminal sends 975 pieces of ticket data through the first gateway, the second gateway receives 775 pieces of ticket data, and the arrival rate is 79.4%. A second IoT terminal sends 443 pieces of ticket data through the second gateway, the first gateway receives 341 pieces of ticket data, and the arrival rate reaches 76.9%. The arrival rate thereof is significantly lower than the result of the previous actual test, and therefore, increasing the deployment height of the gateway can also improve the data transmission performance of the LoRa network channel.

As can be known from the above test results, the output power of the gateway can reach 17 dBm when the IoT data communication between the IoT devices is realized based on Wi-Fi+LoRa network channels, which can satisfy the signal coverage in the visual distance range of not less than 50 m. Therefore, the LoRa network channel has long-distance and low-power data transmission performance, and can meet actual service requirements.

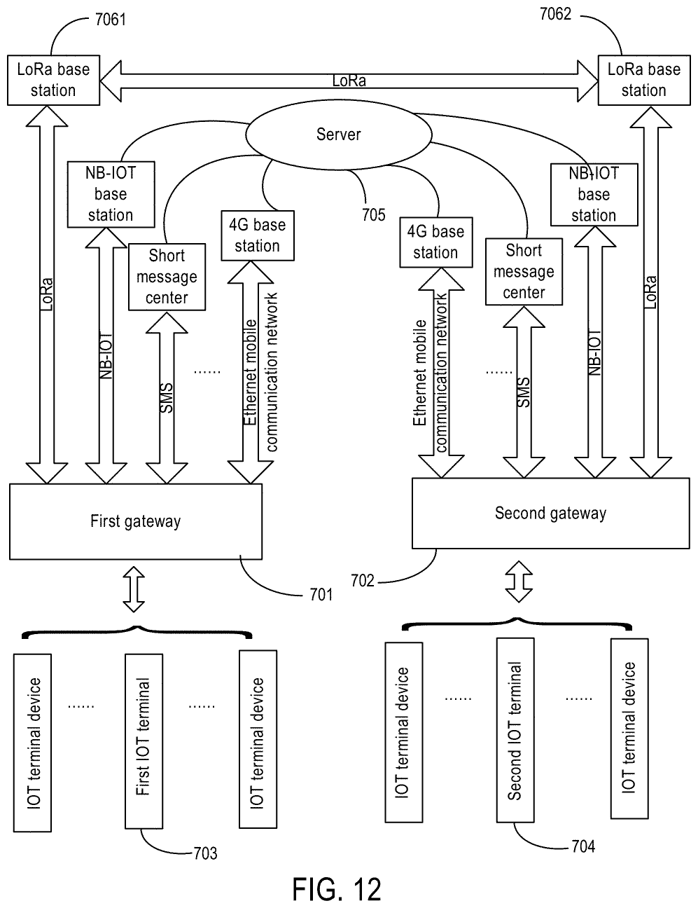

FIG. 12 is a block diagram of a data communication system according to some embodiments of the disclosure. The system may also include a server (705) connected to the plurality of gateways, and at least one self-organizing network base station (706).

The network channel corresponding to any network protocol between any two gateways is formed by the any two gateways each establishing a network connection with the server based on the any network protocol.

In the illustrated embodiment, the first gateway configured to send IoT data to a second gateway through at least two network channels is specifically configured to send the IoT data to the server through the at least two network channels; and the server (705) is configured to receive the IoT data sent by the first gateway (701) through the at least two network channels, determine a second gateway (702) associated with the first gateway (701), and forward the IoT data to the second gateway (702) through the at least two network channels.

In some embodiments, an association relationship between a gateway device and a terminal device is pre-stored in the server, and the IoT data is sent to the second gateway based on determination of the second gateway connected to the second IoT terminal.

In practice, the system further includes a plurality of communication base stations that each support different network protocols.

The network channel corresponding to any network protocol is formed by a network connection established by the first gateway with a first communication base station for the any network protocol based on the any network protocol; a network connection established by the second gateway with a second communication base station for the any network protocol based on the any network protocol; and network connections established by the first communication base station and the second communication base station with the server respectively.

The server receiving the IoT data sent by the first gateway through the at least two network channels is specifically receiving the IoT data sent by the first gateway through at least two first communication base stations.

The server forwarding the IoT data to the second gateway through the at least two network channels is specifically forwarding the IoT data to the second gateway through at least two second communication base stations.

For example, the NB-IoT network corresponds to an NB-IoT network communication base station, and the LoRa network corresponds to a LoRa communication base station. The SMS network may also include a short message center, and the mobile communication network may also include a mobile communication base station and the like.

As can be seen from the foregoing, the first gateway and the second gateway actually need to establish connections with the server through the NB-IoT base station, the short message center, the mobile communication base station, the LoRa base station, and the like based on different network protocols. Thus, the server further needs to determine whether the first gateway and the second gateway access the same network base station or the same short message center. If yes, the network base station or short message center is controlled to send the IoT data to the second gateway; and if no, a network base station or short message center connected to the second gateway is determined, and the network base station or short message center is controlled to send the IoT data to the second gateway.

The plurality of network protocols may include a narrowband IoT (NB-IoT) communication protocol. In one embodiment, if the at least two network channels include the NB-IoT network channel, the server receiving the IoT data sent by the first gateway through the at least two network channels may comprise: receiving the IoT data sent by the first gateway through a first NB-IoT base station in the NB-IoT network channel.

In some embodiments, by optimizing an NB-IoT network protocol layer, the same NB-IoT base station can be accessed by more devices, thus serving more devices. The server forwarding the IoT data to the second gateway through the at least two network channels may comprise: forwarding the IoT data to the second gateway through a second NB-IoT base station in the NB-IoT network channel, so that the second gateway sends the IoT data to the second terminal.

Further, the server forwarding the IoT data to the second gateway through the second NB-IoT base station may comprise: grouping, according to downlink communication capability of the second NB-IoT base station, second gateways connected to the second NB-IoT base station; and controlling the second NB-IoT base station to sequentially forward the IoT data to each group of corresponding second gateways according to the group.

The server may detect the data delivery capability of each NB-IoT base station in advance. When the quantity of the second gateways exceeds the data delivery capability of the base station, for example, the NB-IoT base station has only 8 downlink channels, the communication capability with 8 terminal devices can only be achieved each time. However, there are 16 second gateway devices actually accessed, which far exceeds the data delivery capability of the NB-IoT base station. The server may group the second gateways in advance, for example, divide the 16 second gateways into two groups, and control the NB-IoT base station to send the IoT data twice to the 16 second gateway devices connected to the NB-IoT base station. Therefore, the problem of the quantity of gateways accessing the NB-IoT base station being limited by the data delivery capability of the base station can be avoided, thereby further improving data transmission efficiency of the IoT data.

In one embodiment, the association relationships between the devices are stored in the server. After receiving the IoT data, the server determines, based on the pre-stored association relationships between the devices, the second gateway connected to the second terminal and the network base station or short message center connected to the second gateway, so that the management and control on the IoT data delivery can be achieved. The management and control of the server on the IoT data sending can improve the efficiency of the data communication, improve the security and reliability of the data communication, and further improve the communication quality between the devices.

In one embodiment, the plurality of gateways establish network connections with the respective corresponding self-organizing network base stations (706) based on the at least one self-organizing network protocol, respectively. A self-organizing network channel corresponding to any self-organizing network protocol between any two gateways is formed by network connections established by the any two gateways with the corresponding self-organizing network base stations (706) respectively based on the any self-organizing network protocol. The self-organizing network base station may be a LoRa base station, which is not specifically limited here.

If the at least two network channels are at least two self-organizing network channels, the first gateway (701) sending the IoT data to the second gateway (702) through the at least two network channels is specifically sending the IoT data to the respective corresponding self-organizing network base stations (706) through the at least two self-organizing network channels.

The self-organizing network base station (706) is configured to determine the second gateway (702) associated with the first gateway (701), and send the IoT data to the second gateway (702) through the corresponding self-organizing network channel.

Taking the LoRa network channel as an example. If the first gateway (701) and the second gateway (702) respectively access a first LoRa base station (706)1 and a second LoRa base station (706)2, in this case a self-organizing network base station 804 is configured to determine the second gateway (702) associated with the first gateway (701). The sending the IoT data to the second gateway (702) through the corresponding self-organizing network channel is specifically determining, by the first LoRa base station (706)1, the second LoRa base station (706)2 connected to the second gateway (702), and sending the IoT data to the second LoRa base station (706)2; and determining, by the second LoRa base station (706)2, the second gateway (702) associated with the first gateway (701), and sending the IoT data to the second gateway (702) through the LoRa network channel.

In some embodiments, the self-organizing network base stations (706) in the system can also respectively establish network connections with the server (705) to form a self-organizing network channel between the first gateway (701) and the second gateway (702). Implementation examples of the disclosure have been described in detail in the foregoing, and will not be described herein again.

The specific implementation of the embodiments of the disclosure have been described in detail in the foregoing, and will not be described herein again

In one embodiment, the association relationships between the devices are stored in the self-organizing network base station in advance, and the second gateway connected to the second IoT terminal as well as the self-organizing network base station connected to the second gateway are determined based on the association relationships between the devices, so that the management and control on the IoT data delivery may be achieved. The management and control of the self-organizing network base station on the IoT data sending can not only reduce users' costs of using the network, but can also improve the data communication, improve security and reliability of the data communication, and further improve communication quality between the devices.

Those skilled in the art can clearly understand that for convenience and simplicity of description, for the specific working process of the system, apparatus, and units described above, reference may be made to the corresponding process in the foregoing method embodiments, which will not be described herein again.

The apparatus embodiment described above is merely exemplary. The units described as separate parts may or may not be physically separated; and the components shown as units may or may not be physical units. That is, the components may be located in one place or may be distributed onto a plurality of network units. The objective of the solution of this embodiment may be achieved by selecting some or all of the modules according to actual requirements. Those of ordinary skill in the art can understand and implement the present invention without creative efforts.

Through the description of the above implementations, those skilled in the art can clearly understand that the various implementations can be implemented by means of software plus a necessary general hardware platform, and definitely can be implemented by hardware. Based on such understanding, the above technical solution essentially or the portion contributing to the prior art may be embodied in the form of a software product. The computer software product may be stored in a computer readable storage medium, such as a ROM/RAM, a magnetic disk, or an optical disc, and include several instructions that enable a computer device (which may be a personal computer, a server, or a network device) to implement the method in the various embodiments or certain portions of the embodiments.

Finally, it should be noted that the above embodiments are merely provided for describing the technical solutions of the disclosure, but not intended to limit the disclosure. It should be understood by those of ordinary skill in the art that although the disclosure has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the technical solutions in the embodiments of the disclosure.

What is claimed is:

1. A device comprising:
a plurality of server communication components supporting different respective network protocols, each server communication component configured to establish network connection with a corresponding server using the respective network protocol; and
a processing component communicatively coupled to each of the server communications components and configured to:
identify at least two selected server communication components from the plurality of server communication components,
establish at least two network connections using the selected server communication components,
receive Internet-of-Things (IoT) data from a plurality of IoT terminals,
cache the IoT data in a shared protocol stack queue, and
transmit a portion of the IoT data stored in the shared protocol stack queue to a server through the at least two server communication components.

2. The device of claim 1, the gateway further comprising a plurality of terminal communication components configured to establish network connections with the plurality of IoT terminals based on a respective corresponding network protocol; and the receiving IoT data from the plurality of IoT terminals comprising performing IoT data communication with the IoT terminals through the terminal communication components.

3. The device of claim 2, the processing component further configured to receive first IoT data through a first terminal communication component connected to the first IoT terminal, and control the server communication components to send the first IoT data to the corresponding server.

4. The device of claim 3, the processing component further configured to receive, through the server communication components, second IoT data sent by the server, and control the first terminal communication component connected to the first IoT terminal to send the second IoT data to the first IoT terminal.

5. The device of claim 2, the server communication components including at least one Narrow Band IoT (NB-IoT) communication component, and a terminal communication component connected to the first IoT terminal comprises a ultra-long-range low-power data transmission network (LoRa) communication component, wherein the processing component is configured to perform protocol conversion on a communication protocol of the IoT data transmitted between the terminal communication component and the server communication components are configured to perform protocol conversion on a communication protocol of IoT data transmitted between the NB-IoT communication component and the LoRa communication component.

6. The device of claim 2, further comprising a near-field communication (NFC) component connected to the processing component and configured to store networking information of a terminal communication component and, after an interconnection request for the terminal communication component sent by any IoT terminal within a preset distance is received, send networking information of the terminal communication component to the an IoT terminal.

7. The device of claim 2, the terminal communication component comprising a communication component selected from the group consisting of a wireless fidelity (Wi-Fi) communication component, a Bluetooth communication component, a LoRa communication component, and a local area network (LAN) communication component.

8. The device of claim 2, further comprising a display component connected to the processing component, wherein the processing component is further configured to acquire working state information of each IoT terminal through the terminal communication components, and control the display component to display the working state information.

9. The device of claim 1, the plurality of server communication components further configured to establish network connections with a plurality of IoT terminals based on corresponding network protocols, wherein the processing component is further configured to perform IoT data communication with at least one IoT terminal through the server communication components.

10. The device of claim 1, the plurality of server communication components including a self-organizing network communication component configured to establish a network connection with a self-organizing network base station based on a self-organizing network protocol, wherein the processing component is further configured to select the self-organizing network communication component, and perform IoT data communication with the self-organizing network base station through the self-organizing network communication component.

11. The device of claim 1, the plurality of server communication components including a communication component selected from the group consisting of a wide area network (WAN) communication component, a LoRa communication component, a mobile communication and short message server (SMS) communication component, and an NB-IoT communication component.

12. The device of claim 1, further comprising a real-time clock (RTC) component connected to the processing component configured to provide time information for the processing component.

13. The device of claim 1, further comprising a positioning component configured to receive a positioning instruction sent by the processing component, collect current location information based on the positioning instruction, and send the current location information to the processing component, wherein the processing component is configured to control the positioning component to collect current location information, and send the current location information to the server through the at least two server communication components.

14. The device of claim 1, further comprising at least one sensing component configured to collect environmental information in the surrounding environment.

15. The device of claim 1, further comprising a battery component configured to supply power to the processing component.

16. The device of claim 17, further comprising a battery management component connected to the processing component and the battery component configured to acquire electric quantity information of the battery component, and perform charge and discharge management of the battery component based on the electric quantity information.

17. A method comprising:
establishing, via a plurality of server communication components, a plurality of network connections with a corresponding server, each of the network connections established using a different respective network protocol;
identifying, by a processing component communicatively coupled to each of the server communications components, at least two selected server communication components from the plurality of server communication components,
establishing, by the processing component, at least two network connections using the selected server communication components,
receiving, by the processing component, Internet-of-Things (IoT) data from a plurality of IoT terminals,
caching, by the processing component, the IoT data in a shared protocol stack queue, and
transmitting, by the processing component, a portion of the IoT data stored in the shared protocol stack queue to a server through the at least two server communication components.

18. The method of claim 17, further comprising establishing, via a plurality of terminal communication components, network connections with the plurality of IoT terminals based on a respective corresponding network protocol; and the receiving IoT data from the plurality of IoT terminals comprising performing IoT data communication with the IoT terminals through the terminal communication components.

19. The method of claim 18, further comprising receiving first IoT data through a first terminal communication component connected to the first IoT terminal, and controlling the server communication components to send the first IoT data to the corresponding server.

20. A non-transitory computer readable storage medium for tangibly storing computer program instructions capable of being executed by a computer processor, the computer program instructions defining the steps of:
establishing, via a plurality of server communication components, a plurality of network connections with a corresponding server, each of the network connections established using a different respective network protocol;
identifying at least two selected server communication components from the plurality of server communication components,
establishing at least two network connections using the selected server communication components,
receiving data from a plurality of terminals,
caching the data in a shared protocol stack queue, and
transmitting a portion of the data stored in the shared protocol stack queue to a server through the at least two server communication components.
